(19) United States
(12) Patent Application Publication
(10) Pub. No.: US 2024/0348277 A1
(43) Pub. Date: Oct. 17, 2024

(54) PHONE CASE WITH TOUCH CAPABILITIES

(71) Applicant: Tom Cannuscio, Penn Valley, PA (US)

(72) Inventor: Tom Cannuscio, Penn Valley, PA (US)

(21) Appl. No.: 18/633,807

(22) Filed: Apr. 12, 2024

Related U.S. Application Data
(60) Provisional application No. 63/458,670, filed on Apr. 12, 2023.

(51) Int. Cl. H04B 1/3888; G06F 3/0354; H04M 1/02

(52) U.S. Cl. CPC H04B 1/3888; G06F 3/03547; H04M 1/0274; G06F 2203/0339

(57) ABSTRACT

A phone case that has touch capabilities is disclosed. The phone case comprises associated electronics and/or materials that allows the phone case to be used in conjunction with a smartphone to allow a user the ability to have touch capabilities simply by depressing one or more edges of a phone case. The phone case with touch capabilities may be used in conjunction with a smartphone that maintains its own touch capabilities on the phone screen. The phone case may alternatively possess transmitting touch capabilities so that it can be used with and control other touch screens. The phone case may possess the ability to toggle between receiving and transmitting touch capabilities.

### CROSS-REFERENCE TO RELATED APPLICATIONS

The present application claims priority under 35 USC 119 (c) to U.S. Provisional Application No. 63/458,670 filed Apr. 12, 2023, the entire contents of which is incorporated by reference.

### FIELD OF THE INVENTION

The present invention relates to a phone case that has touch capabilities. The phone case comprises associated electronics and/or materials that allows the phone case to be used in conjunction with a smartphone or another touchscreen to allow a user the ability to have touch capabilities simply by depressing the edge and/or corners of a phone case or having the phone case touch the other touchscreen. In an embodiment, the phone case with touch capabilities may be used in conjunction with a smartphone or another touchscreen that maintains its own touch capabilities on the phone screen or the other touchscreen.

### BACKGROUND OF THE INVENTION

A Number of inventors and people have made contributions to the current touchscreen technology.

Alan Turing, while studying for his Ph.D. at Princeton University in 1936 published a paper entitled “On Computable Numbers, with an application to the Entscheidungsproblem”, which some argue was the first paper that laid a foundation for the development of computers and computer science. In the 1950s, computer graphics were first appearing in the devices of the time and these devices employed “light pens” that combined the use of a stylus with a photocell and electrical wires.

In the 1960s and 1970s, work was being done by computer scientists who tried to develop technologies that would allow humans to directly control what was seen on a screen. Of note, during this time period, Douglas Engelbart developed what many acknowledge to be the early forerunner of the mouse, Ivan Southerland was a pioneer who worked on the early computer graphics and virtual reality, and Alan Kay worked on the early prototypes of what has become the modern computer monitor.

In 1974, George Hurst and William C Colwell filed a patent application that was issued as U.S. Pat. No. 3,911,215 which many acknowledge to be the first touch sensor technology. Their invention related to a sensor construction for normally maintaining two juxtaposed electrical potential carrying sheets, at least one being flexible, separated from each other but permitting contact therebetween when an object of specified radius of curvature is pressed against the flexible sheet. The separation of the sheets is accomplished by producing discrete small buttons of insulation, preferably on the flexible sheet, with the spacing and the height of the buttons determining the largest radius of curvature to which the sensor will respond. This construction is specifically applied to a telescriber sensor or the like whereby contact is made only by depression of the flexible sheet with a writing instrument and not by any portion of a writer's hand. Their technology was directed to the use of a stylus type of implement which could deform the flexible sheet (and not the hand).

In 1987, a touch operated tablet computer entitled the “Linus Write Top” allowed people to write directly on to a computer screen with a stylus. A series of personal digital assistants (PDAs) were released by Apple in the early 1990s called the Newton that was the first to have handwriting recognition. The “Notes” application allowed users to create documents that could contain text that had been typed or text that was recognized from handwriting or sketches. In 2007, Apple released the first of its iPhones, which uses one of the touch technologies that exists today on some of today's touch devices.

The most common application for touch screens today is probably smart phones.

The technology behind touchscreens is very elegant and may be complex, but the use of touch screens is quite simple from a user's perspective. The user simply has to touch or point to the position on the screen where some manipulation is to be made. The underlying technology may be complex, but it is accurate and reproducible. The touchscreen technology is useful for a wide variety of applications and can easily be employed in a manner in which the public has access to an accurate and reproducible technology. Touch screens are useful for voting machines, self serve checkout machines at grocery stores, public kiosks, car computer screens, personal computers, cell phones, ticket purchasing machines at subways/bus stations/train stations, game consoles, menu machines at restaurants, ordering machines at fast food restaurants, touch screen point of sale tablets at cafes and shops, automated teller machines, thermostats, household utility/light controllers, televisions, and on other machines at a plurality of locations.

One drawback to touch screen technology is that if the public is using a touch screen, germs may be passed from one user to the next. Other drawbacks of all touch screens include that when pressing the screen, the user may obscure the screen so that the desired option cannot be clearly seen when selecting the desired option. Another drawback to touchscreens is that if a user has one of his/her hands occupied (e.g., carrying a package or purchased item and the other hand is holding a mobile phone), the user may not be able to perform specific tasks. For example, if the user is attempting to manipulate a public touch screen, it would be desirable to be able to manipulate the public touch screen with a hand while not having to touch the public touch screen. It would be desirable to have a hand holding a mobile phone be able to manipulate another touch screen by using one or more corners of the phone that is held. Smudging of the touchscreen (or getting the touch screen dirty) may also impede the ability of the touchscreen to be viewed. Repetitive touching of the glass on a touch screen may also result in damage, which can lead to the touch screen not working or working to the extent that lagging signaling may occur. The damage may occur to the resistive layers in the touch screen. Repetitive touching may also result in a plastic upper layer that becomes somewhat opaque (and not a crystal clear transparency) due to dirt/particles that adhere to the plastic upper layer. In the technologies that do not actually require the screen to be touched for it to register, there is always the danger of extraneous signals being registered thereby giving the user a response that the user may not desire.

Moreover, when complex tasks are to be performed on a touch-screen (like copying and pasting text), users tend to prefer not using a touch screen as the touch screen may be finicky or exacting and the user may not have the control over the task that the user wants if using a touch screen. In these situations, users tend to prefer the use of a mouse or of some external means of providing precise control over the task to be accomplished. Moreover, when one hand is unavailable, it would be beneficial to have the capacity to manipulate a touch screen with the other hand. For example, if one is carrying a package that occupies one hand, it would be beneficial to be able to manipulate the touchscreen without having to put the package down. It is with all of these drawbacks in mind that the present invention was developed.

### BRIEF SUMMARY OF THE INVENTION

The present invention relates to a smartphone or a phone case that has touch screen technology on the sides of the smartphone or on the edges of the phone case. In an embodiment, the system/method includes electronics and/or materials that are necessary for the touch device to work. If the touch device is the phone case, the electronics/materials to allow transmitting/receiving capabilities are integrated with the phone or the phone case so that a touch on the phone case leads to a cursor on the phone moving. In an embodiment, the phone case will have one or more buttons that allows one to “click” on the one or more buttons to change the phone case's capabilities to either receiving or transmitting touch capabilities. In one variation, the transmitting capabilities allow the phone case to be used as a stylus in conjunction with another touch screen thereby obviating the need for the user to touch the other touchscreen.

### BRIEF DESCRIPTION OF THE SEVERAL VIEWS OF THE DRAWING

FIG. 1 shows a top down view of a smart phone and the phone case with touch capabilities.

FIG. 2 shows a top down view of a smart phone and the user using the phone case with touch capabilities.

FIG. 3 shows a side view of a smart phone in one embodiment of the invention.

FIG. 4 shows an embodiment wherein the corner of the phone case has touch transmitting capabilities can be used in conjunction with another touch screen.

### DETAILED DESCRIPTION OF THE INVENTION

In an embodiment, the present invention relates to a phone case with touch capabilities. There are a number of different types of technology that offer touch capabilities. Included in these technologies are resistive technologies, capacitive technologies, infrared technologies, surface acoustic wave technologies, light pen technologies, and near field imaging technologies. Some of the technologies are capable of sensing multiple inputs at one time whereas others are limited to only being able to sense one input at a time. For example, one can touch a screen with two fingers at the same time and with movement of each finger simultaneously, the screen can be expanded or contracted, depending on how the fingers are moved.

Resistive touchscreens are akin to “transparent keyboards” positioned on top of the screen. A flexible upper layer is present as a top layer wherein a conducting polyester plastic is bonded to a layer of conducting glass as a lower layer wherein the two layers are separated by an insulating membrane. When one depresses the screen, the polyester layer touches the glass and completes the circuit and the completed circuit sends a signal—this is comparable to the action that takes place on a keyboard. A computer chip positioned in the screen is able to ascertain the coordinates on the screen that have been touched. Resistive technology is able to handle two (or more inputs) at once so that screens can be expanded or contracted depending on how the screen is touched and the movement of the touching apparatus (such as a finger).

Capacitive screens are another technology wherein the screens are made from multiple layers of glass. The inner layer and the outer layer of glass both conduct electricity, so the screen essentially has two electrical conductors on the outside wherein the inner glass layers function as an insulator (the difference in voltage between the layers and the insulator means the screen acts as a capacitor). By touching the screen with an electrical conductor such as a finger, the electrical field is altered, and the position of one's finger on the screen alters the electrical signals at different amounts depending on where the finger touches the screen. This varying amount can be read by electrical sensors that let a processing device (such as a computer chip) know where the screen has been touched. Similar to resistive technology, the screen can be touched at two points and the screen can “sense” the two separate points, allowing both screen expansion and contraction. Resistive technology works to some extent by physical means (the depression of the flexible layer onto the non-flexible layer) whereas capacitive technology works by an electrical signal and does not need physical movement of the device/screen to take place.

Infrared technology works by using a grid pattern of LEDs and photocells that act as light detectors arranged on opposite sides of the screen. The LEDs function by shining infrared radiation onto the front of the screen. When a finger touches the screen, the beams of light are interrupted and the signal is read and a microchip processor is able to calculate the position where the interrupted beam has occurred. Infrared technology allows the user to simultaneously have two inputs on the screen. Infrared technology does not require the conductive touch that the capacitive technology does, nor the physical means (e.g., the depression of a flexible layer) that the resistive technology does.

Surface Acoustic wave technology works by detecting another region of the electromagnetic spectrum that differs from infrared technology. It uses sound waves instead of light waves. It uses sound waves that are of a very high frequency (that cannot be heard by humans) wherein the waves are generated at the edges of the screen and traverse back and forth across the screen. The sound waves are interrupted when one touches the screen and a processor and a microchip are able to determine the position of the touch by using mathematical algorithms such as Fourier transform technology that allows the microchip to ascertain the position of the touch by the change in or absence of frequency that results when a touch occurs.

Near field imaging, like capacitive technology, relies to some extent on the disruption of an electromagnetic field in order to generate signals. The physical presence of a finger (or any conductive product) or of a non-conductive device (such as a plastic stylus) near the screen has the effect of modifying the electromagnetic field on the glass screen, which can be detected by sensors and processed by one or more microchips. When the electromagnetic field is disrupted to an extent wherein the glass screen is actually touched, a signal is generated (e.g., this technology relies to some extent on a calibration curve wherein a threshold signal determines when the signal is detected). This technology is very robust in that it can be used in environments wherein the glass screen is not very clean (for example, it can be used when the screen may have mud on it) or in environments wherein the user may be wearing winter gloves.

Light pens operate on the principle that they possess a photoelectric cell that can detect an electron beam on a cathode ray tube type computer screen. The light pen(s) is/are able to detect the position wherein the electron beam is being detected by the light pen. The light pen is able to send a signal to a computer that is able to detect the position where the light pen is pointing at the computer screen. Light pens could be used to select menu items or text from the screen (using a technology similar to a mouse) or alternatively, be used to draw computer graphics.

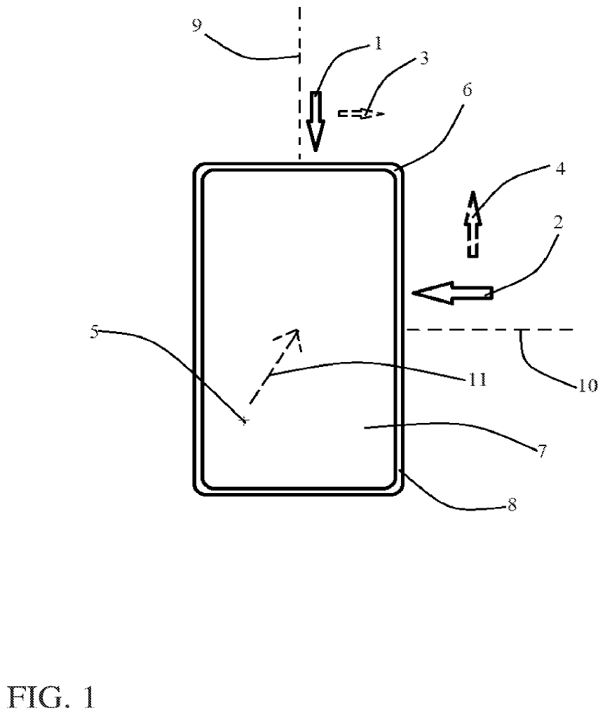

FIG. 1 shows one embodiment of the invention. In an embodiment, the phone has a phone case 8 and a phone screen 7. In an embodiment, one can depress a button (not shown) on the phone case 8, which allows a cursor 5 to appear on phone screen 7. In an embodiment, the touch capabilities of the phone case 8 are in the upper right hand quadrant of the phone case 8 near corner 6. The touch capabilities extend from corner 6 to horizontal imaginary line 10 and from corner 6 to vertical imaginary line 9. Vertical imaginary line 9 bisects the top of the phone case at a half way point along the top of the phone and horizontal imaginary line 10 bisects a first side of the phone case at a half way point along the side of the phone case. By depressing the phone case lightly and simultaneously at vertical arrow 1 and horizontal arrow 2, the cursor 5 is positioned where shown, which is a point position that is the intersection of perfectly vertical and horizontal lines that are drawn that are twice the distance between corner 6 and vertical arrow 1 and twice the distance between corner 6 and horizontal arrow 2. Thus, to position the cursor 5 on the phone screen 7 at a position that is at the oblique corner relative to corner 6, one would lightly and simultaneously depress the phone case 8 at a position on the phone case that is at imaginary vertical line 1 and horizontal imaginary line 2. If one wanted to move the cursor 5 from a position where it is shown in FIG. 1 to a position close to corner 6, one would slide with the depressing element (e.g., a finger) while maintaining contact with the phone case 8 in the direction shown by imaginary horizontal arrow 3 and imaginary vertical arrow 4. The cursor would move in the direction of oblique arrow 11. The sliding along the top (in the direction of imaginary horizontal arrow 3) moves the cursor in a left to right direction while the sliding along the side (in the direction of imaginary vertical arrow 4) moves the cursor in a direction from the bottom of the screen to the top of the screen. Accordingly, by sliding the sliding implement, one can position the cursor 5 wherever one wants on the phone screen 7.

In an embodiment, in order to “click” on a link on the phone or to select (for example) a hyperlink, one should move the cursor to the desired location and then one can depress the side or the top of the case more strongly (i.e., with more force) and that will allow the cursor to select (or click) on the link. In a variation, there may be a button associated with the phone case 8 (not shown) that allows one to “click” on a link. The “clicking” using the button works in a similar manner to a mouse and a computer. In a variation, one might also be able to “double click” on the side of the phone case in a manner similar to using a mouse on a computer, which allows a user to select a link on the phone. In a similar manner, one can use the sides of the phone case to copy and paste text in a manner similar to using a mouse on a computer. For example, there may be two buttons associated with the phone case 8 (which correspond to the left and the right of a computer mouse) wherein each button will have different tasks associated with pushing each of the respective buttons.

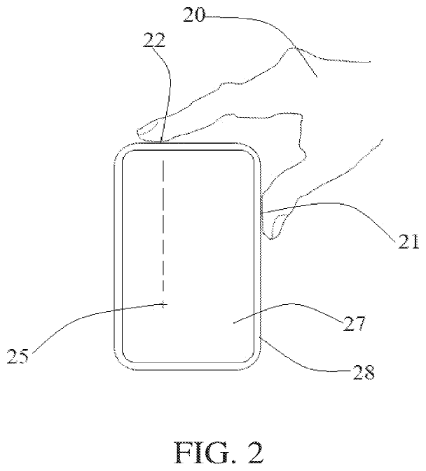

FIG. 2 shows another embodiment of phone case 28 wherein the depressing element is a human hand 20. The index finger at top position 22 and the thumb at side position 21 control the position of cursor 25 on the phone screen 27. In this embodiment, the cursor 25 position is determined by in a left-right manner (the x axis on a cartesian coordinate system) by the position of the index finger. That is, the cursor is directly below the top position 22 where the index finger makes contact with the phone case 28. The cursor 25 position in an up-down manner (the y axis on a cartesian coordinate system) is determined by the side position 21 where the thumb makes contact with the phone case 28. However, in a manner similar to that in FIG. 1, the cursor 25 position in the y direction is two times the distance between the upper right hand corner to the side position 21. The configuration in FIG. 1 or the configuration in FIG. 2 may be preferred configurations for those users who have small hands as the cursor can be moved around the entire screen 27 by only having to access half of the side of the phone case and half of the top (as in FIG. 1) or all of the top (as in FIG. 2).

In an embodiment, one may be able to set his/her preference as to how the position of the cursor is determined. In a variation, there may be a toggle that allows one to change between different configurations of how the cursor position can be determined. In a variation, another configuration may use the entirety of the top and the entirety of the side to determine the position of the cursor and there may be a three way toggle that allows one to switch between the configuration shown in FIG. 1, the configuration shown in FIG. 2, and a configuration wherein the cursor position is determined by the entirety of the top and entirety of the first side. In a variation, the configuration may be designed for those that want to hold the phone with their left hand wherein the second side (i.e., the side opposite the side in FIG. 1 and FIG. 2) controls the position of the cursor. In a variation, the bottom of the phone case may have the touch capabilities. It should be understood that any of a plurality of configurations are possible. The following table 1 lists some of the possibilities.

TABLE 1

| | | Cursor control in a | | Cursor control in a | |
|---|---|---|---|---|---|
| Permutation | | vertical direction | | horizontal direction | |
| 1. | (right hand) | First side | (half way) | Top | (half way) |
| 2. | (right hand) | First side | (half way) | Bottom | (half way) |
| 3. | (right hand) | First side | (entire side) | Top | (half way) |
| 4. | (right hand) | First side | (entire side) | Bottom | (half way) |
| 5. | (left hand) | Second side | (half way) | Top | (half way) |
| 6. | (left hand) | Second side | (half way) | Bottom | (half way) |
| 7. | (left hand) | Second side | (entire side) | Top | (half way) |
| 8. | (left hand) | Second side | (entire side) | Bottom | (half way) |
| 9. | (right hand) | First side | (half way) | Top | (entire side) |
| 10. | (right hand) | First side | (half way) | Bottom | (entire side) |
| 11. | (right hand) | First side | (entire side) | Top | (entire side) |
| 12. | (right hand) | First side | (entire side) | Bottom | (entire side) |
| 13. | (left hand) | Second side | (half way) | Top | (entire side) |
| 14. | (left hand) | Second side | (half way) | Bottom | (entire side) |
| 15. | (left hand) | Second side | (entire side) | Top | (entire side) |
| 16. | (left hand) | Second side | (entire side) | Bottom | (entire side) |

*Half way means that the cursor position is determined by being at a position that is two times the distance of the depressing implement on the phone case.

In a variation, the phone screen 27 may also have touch capabilities. In a variation, when the phone screen 27 has touch capabilities, the phone case 28 may not have touch capabilities. In a variation, when the phone case 28 has touch capabilities, the phone screen 27 may not. In an embodiment, both the phone case 28 and the phone screen 27 may have simultaneous touch capabilities. There may be a toggle button on the phone case 28 that allows the touch capabilities of the phone screen 27 and/or the touch capabilities of the phone case 28 to be turned on and off. In an embodiment, the presence of the cursor 25 on the phone screen 27 may be an indication that the phone case has touch capabilities. In a variation, the cursor may be in different colors, different sizes, or different shapes to allow a user to know if the phone screen 27 has touch capabilities or not. For example, a black color of the cursor may indicate that the phone screen 27 still has touch capabilities but a blue color of the cursor may indicate that the phone screen no longer has touch capabilities. In an embodiment, the toggle button can continue to be pushed until the user achieves the desired configuration.

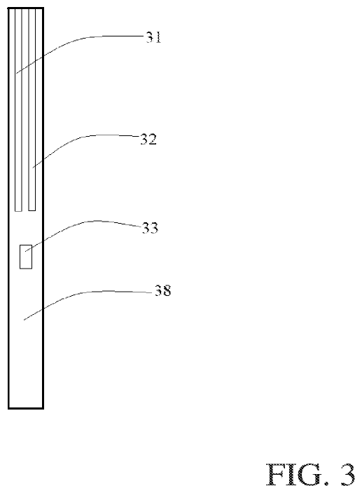

FIG. 3 shows a side view of one embodiment of the phone case 38. The phone case 38 may have a toggle button 33 that allows a user to toggle between different cursor configurations as discussed herein. In this embodiment, the phone case has touch capabilities on half of the length on a first side (or second side) of the phone case. In an embodiment, vertical touch strip 31 may have the appropriate electronics associated with it that allows for the vertical touch strip 31 to have touch capabilities, which thereby, in one embodiment, controls the cursor on the phone screen. In an embodiment, vertical click strip 32 may have functionality that allows a user to click on the vertical click strip that has functionalities similar to what one would experience on a mouse that is being used on a computer. That is, by depressing the vertical click strip 32, a user can select a hyperlink or perform other functions similar to what one would do with a mouse and the associated computer on which the mouse is being used. In an embodiment, the vertical touch strip 31 may be present and the vertical click strip 32 may not and the vertical touch strip 31 may perform the functions similar to a mouse. In a variation, the vertical touch strip 31 and the vertical click strip 32 may respectively perform the functions similar to the left click and the right click on a mouse. For example, the vertical click strip 32 may bring up menus on the screen of the phone, whereas the vertical touch strip 31 may perform the functions associated with the left click on a mouse (e.g., selecting hyperlinks).

It should be understood that although the half way configuration is shown in FIG. 3, other configurations are possible. For example, the position of toggle button 33 can be moved, and the vertical click strip 32 and vertical touch strip 31 may go along the entire length of the phone case 38.

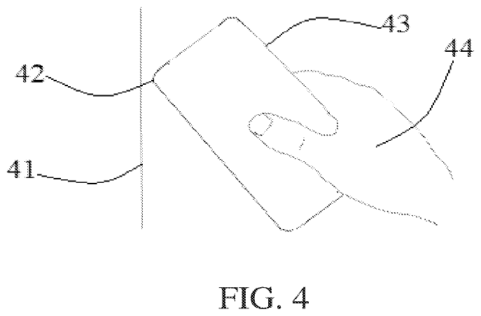

In an embodiment, and as shown in FIG. 4, the phone case itself may have touch capabilities (similar to a person's finger or a stylus). In this embodiment, the phone case 43 may have a corner 42 that has transmitting touch capabilities against a computer screen 41 that has receiving touch capabilities. A user's hand 44 may be able to orient the phone in an oblique position so that the corner 42 is able to be used as the element that is operationally able to be the element that acts as a stylus against the computer screen with receiving touch capabilities (and thus, has similar capabilities to a hand that touches a computer screen 41 with receiving touch capabilities). In this embodiment, the corner has the requisite electronics and/or materials to control a cursor that appears on a computer screen or to perform the usual functions that a hand that touches a computer screen with touch capabilities is able to perform. In this embodiment, this is an advantageous embodiment because it addresses the drawback of the prior art that allows the user to avoid having to touch the touch screen that may be touched by the public. The one or more corners can serve the purpose of a stylus or finger. In this embodiment, the user will not be required to put down purchased items that are occupying one hand of the user and the user can use one or more corners of his/her phone that is in the other hand. In this embodiment, the user will not need to touch the public touch screen with his/her finger. For example, in an embodiment, it is contemplated and therefore within the scope of the invention that the corner 42 may be able to control, for example, touch screens that are used as voting machines, self serve checkout machines at grocery stores, public kiosks, car computer screens, personal computers, cell phones, ticket purchasing machines at subways/bus stations/train stations, game consoles, menu machines at restaurants, ordering machines at fast food restaurants, touch screen point of sale tablets at cafes and shops, automated teller machines, thermostats, household utility/light controllers, televisions, and on other machines at a plurality of locations. Any of these plurality of computer screens may be represented by computer screen 41. Accordingly, by using the corner 42 of a phone case 43, a user may not have to expose his/her fingers to bacteria or viruses that may be present on public touch screens.

In an embodiment, the transmitting touch capabilities of the phone case may not be in a corner but may be on an edge of the phone case. In an embodiment, the transmitting touch capabilities may be in both the corner 42 and along the edge of the phone case. The corner 42 may be advantageous because it is essentially a point (like a finger) and it allows the user to interact with a precise location on a computer screen. It should be understood that when a corner is referenced, that the transmitting touch capabilities may be in one or more of the corners so that all or any number of the corners have the transmitting touch capabilities. In one variation, there may be a button or a switch in conjunction with the phone case that serves as a toggle to allow one corner to be selected for touch capabilities (and alternately allows for one to select which corner has the capabilities), or allows for more than one corner to be selected. In a variation, if the transmitting touch capabilities are present on an edge of the phone, the touch capabilities may be localized to one particular location on the edge of the phone case thereby meaning that the transmitting touch feature (i.e., the feature that has the electronics that allows one to control another computer screen with touch capabilities) may be localized to a single point.

Thus, the present invention relates to a phone case that has both receiving touch capabilities (for example, to control the cursor on a phone screen as described above in FIGS. 1-3) and transmitting touch capabilities (for example, as shown in FIG. 4). In an embodiment, both of these abilities may be present in the same phone case. In a variation, there may be a button, switch, or some other means on the phone case that allows one to toggle between these two capabilities. The capability to toggle between transmitting capability and receiving capability may also be ascertained by reading the facial features on a user (for example, a wink may be read by the phone to mean that the toggle should be activated to switch capabilities. It should be apparent that the toggle between the transmitting capability and the receiving capability of the phone case (or the edge of the phone case) may prove to be beneficial to users when one of the user's hands are occupied. By toggling to the transmitting capability the user will not have to worry about only having one hand available to use the phone capabilities when faced with another touch screen (that the user may not want to touch).

It should be understood that the phone case may have only transmitting capabilities or only receiving capabilities or may have both transmitting and receiving capabilities.

In an embodiment, the present invention relates to a phone case comprising: a) a plastic molded part that comprises an outside of the phone case the outside of the phone case comprises a back, and edge; the edge comprising two sides, a top and a bottom of the phone case, the two sides comprising a first side and a second side, and b) an electronics part,
wherein the electronics part comprises electronics that are operationally attached to a phone that comprises a screen, the electronics able to register input from a touch from an individual at a plurality of given positions on the phone case, wherein each of the plurality of given positions on the phone case corresponds to a unique corresponding position of a cursor on the screen of the phone, wherein when the touch occurs at any of the plurality of given positions on the outside of the phone case, the cursor moves to said unique corresponding position on the screen of the phone.

In a variation, the electronics comprises one or more technologies selected from the group consisting of resistive technologies, capacitive technologies, infrared technologies, surface acoustic wave technologies, light pen technologies, and near field imaging technologies.

In a variation, the touch is registered using a finger or a stylus. In a variation, the electronics are operationally attached to a processor and/or one or more computer chips.

In a variation, the input is registered by two or more simultaneous touches at two or more positions on the outside of the phone case. In a variation, the input is registered by two simultaneous touches at two positions on the outside of the phone case.

In an embodiment, the back is unable to register input from the touch. In a variation, only the edge of the phone case is able to register input from the touch. In a variation, the input from a touch is made at two locations on the edge of the phone case. In a variation, the input is registered by the two simultaneous touches on the edge of the phone case. In a variation, the input is registered by the two simultaneous touches, the two simultaneous touches occurring on a) the first side and b) the top or the bottom.

In an embodiment, the cursor can be moved by sliding the touch to a different position along the first side and/or the top or the bottom.

In an embodiment, the present invention relates to a phone case comprising: a) a plastic molded part that comprises an outside of the phone case the outside of the phone case comprises a back, and edge; the edge comprising two sides, a top and a bottom of the phone case, the two sides comprising a first side and a second side, and b) an electronics part,
wherein the electronics part comprises electronics that are operationally attached to a phone that comprises a screen, the electronics able to register input from a touch from an individual at a plurality of given positions on the phone case, wherein each of the plurality of given positions on the phone case corresponds to a unique corresponding position of a cursor on the screen of the phone, wherein when the touch occurs at any of the plurality of given positions on the outside of the phone case, the cursor moves to said unique corresponding position on the screen of the phone, wherein the electronics comprise resistive technologies, capacitive technologies, infrared technologies, surface acoustic wave technologies
wherein the electronics in the phone case are operationally attached to electronics on an inside of the phone.

In a variation, the electronics in the phone case are operationally attached to the electronics on the inside of the phone by wireless technology. In an embodiment, the electronics in the phone case are operationally attached to the electronics on the inside of the phone by wired technology. In a variation, the input is registered by two or more simultaneous touches at two or more positions on the outside of the phone case. In a variation, the plastic molded part comprises thermoplastic polyurethane and polycarbonate or combinations thereof.

In an embodiment, the present invention relates to a method of moving a cursor on a screen of a phone, the method comprising: attaching a phone case to the phone; said phone case comprising: a. a plastic molded part that comprises an outside of the phone case the outside of the phone case comprises a back, and edge; the edge comprising two sides, a top and a bottom of the phone case, the two sides comprising a first side and a second side, and b. an electronics part, wherein the electronics part comprises electronics that are operationally attached to the phone, the electronics able to register input from a touch from an individual at a plurality of given positions on the phone case, wherein each of the plurality of given positions on the phone case corresponds to a unique corresponding position of a cursor on the screen of the phone, wherein when the touch occurs at any of the plurality of given positions on the outside of the phone case, the cursor moves to said unique corresponding position on the screen of the phone.

In a variation, the input is registered by two simultaneous touches, the two simultaneous touches occurring on a) the first side and b) the top or the bottom.

In a variation, the electronics in the phone case are operationally attached to the electronics on the inside of the phone by wireless technology.

In an embodiment, the present invention relates to a method of using a phone case to generate and move a cursor on a phone screen, the method comprising using the index finger and the thumb to depress the edges of a phone case, wherein the act of depressing the phone case may generate the presence of a cursor on the phone screen that is associated with a phone that has the phone case on the phone. In an embodiment, the cursor can be moved by sliding movement by the index finger and the thumb along the edges of the phone case wherein the cursor responds in a corresponding manner to the sliding movement of the index finger and the thumb. For example, if the index finger moves in a sliding movement from left to right, the cursor moves on the screen in a direction from left to right. Similarly, sliding movement of the thumb in a direction from down to up moves the cursor on the phone screen in a direction from down to up. In a variation, there may be a button on the phone case that when depressed causes the appearance (and/or disappearance) of the cursor. The cursor can be moved in a diagonal direction by a simultaneous sliding movement of the index finger and the thumb.

In an embodiment, the cursor can be selected (similar to a mouse click) by depressing the edge of the phone case harder. Thus, there may be more than one level of pressure that the edge of the phone case can detect. For example, if the edge of the phone case is depressed with a lighter pressure, this lighter pressure may be sufficient to move the cursor. Pressing the edge of the phone case with a higher pressure may cause the cursor to be selected (e.g., clicked), for example, allowing the user to link to a hyperlink or to allow the start of highlighting text. The edge may also have double clicking abilities (similar to a mouse) that allows functionalities similar to the functionalities that a mouse has on a computer screen. The double clicking functionality, in one embodiment, rests with the edge where the index finger may be. In a variation, the double clicking functionality may rest with the edge where the thumb encounters the edge. See FIG. 2, for example.

It should be understood and it is contemplated and within the scope of the present invention that any feature that is enumerated above can be combined with any other feature that is enumerated above as long as those features are not incompatible. Whenever ranges are mentioned, any real number that fits within the range of that range is contemplated as an endpoint to generate subranges. In any event, the invention is defined by the below claims.

I claim:

1. A phone case comprising:
a) a plastic molded part that comprises an outside of the phone case the outside of the phone case comprises a back, and edge; the edge comprising two sides, a top and a bottom of the phone case, the two sides comprising a first side and a second side, and
b) an electronics part,
wherein the electronics part comprises electronics that are operationally attached to a phone that comprises a screen, the electronics able to register input from a touch from an individual at a plurality of given positions on the phone case, wherein each of the plurality of given positions on the phone case corresponds to a unique corresponding position of a cursor on the screen of the phone, wherein when the touch occurs at any of the plurality of given positions on the outside of the phone case, the cursor moves to said unique corresponding position on the screen of the phone.

2. The phone case of claim 1, wherein the electronics comprises one or more technologies selected from the group consisting of resistive technologies, capacitive technologies, infrared technologies, surface acoustic wave technologies, light pen technologies, and near field imaging technologies.

3. The phone case of claim 1, wherein the touch is registered using a finger or a stylus.

4. The phone case of claim 2, wherein the electronics are operationally attached to a processor and/or one or more computer chips.

5. The phone case of claim 1, wherein the input is registered by two or more simultaneous touches at two or more positions on the outside of the phone case.

6. The phone case of claim 2, wherein the input is registered by two simultaneous touches at two positions on the outside of the phone case.

7. The phone case of claim 1, wherein the back is unable to register input from the touch.

8. The phone case of claim 1, wherein only the edge is able to register input from the touch.

9. The phone case of claim 8, wherein the input from a touch is made at two locations on the edge of the phone case.

10. The phone case of claim 6, wherein the input is registered by the two simultaneous touches on the edge of the phone case.

11. The phone case of claim 10, wherein the input is registered by the two simultaneous touches, the two simultaneous touches occurring on a) the first side and b) the top or the bottom.

12. The phone case of claim 11, wherein the cursor can be moved by sliding the touch to a different position along the first side and/or the top or the bottom.

13. A phone case comprising:
a) a plastic molded part that comprises an outside of the phone case the outside of the phone case comprises a back, and edge; the edge comprising two sides, a top and a bottom of the phone case, the two sides comprising a first side and a second side, and
b) an electronics part,
wherein the electronics part comprises electronics that are operationally attached to a phone that comprises a screen, the electronics able to register input from a touch from an individual at a plurality of given positions on the phone case, wherein each of the plurality of given positions on the phone case corresponds to a unique corresponding position of a cursor on the screen of the phone, wherein when the touch occurs at any of the plurality of given positions on the outside of the phone case, the cursor moves to said unique corresponding position on the screen of the phone, wherein the electronics comprise resistive technologies, capacitive technologies, infrared technologies, surface acoustic wave technologies
wherein the electronics in the phone case are operationally attached to electronics on an inside the phone.

14. The phone case of claim 13, wherein the electronics in the phone case are operationally attached to the electronics on the inside of the phone by wireless technology.

15. The phone case of claim 13, wherein the electronics in the phone case are operationally attached to the electronics on the inside of the phone by wired technology.

16. The phone case of claim 13, wherein the input is registered by two or more simultaneous touches at two or more positions on the outside of the phone case.

17. The phone case of claim 13, wherein the plastic molded part comprises thermoplastic polyurethane and polycarbonate.

18. A method of moving a cursor on a screen of a phone, the method comprising:
attaching a phone case to the phone; said phone case comprising:
a. a plastic molded part that comprises an outside of the phone case the outside of the phone case comprises a back, and edge; the edge comprising two sides, a top and a bottom of the phone case, the two sides comprising a first side and a second side, and
b. an electronics part,
wherein the electronics part comprises electronics that are operationally attached to the phone, the electronics able to register input from a touch from an individual at a plurality of given positions on the phone case, wherein each of the plurality of given positions on the phone case corresponds to a unique corresponding position of a cursor on the screen of the phone, wherein when the touch occurs at any of the plurality of given positions on the outside of the phone case, the cursor moves to said unique corresponding position on the screen of the phone.

19. The method of claim 18, wherein the input is registered by two simultaneous touches, the two simultaneous touches occurring on a) the first side and b) the top or the bottom.

20. The method of claim 18, wherein the electronics in the phone case are operationally attached to the electronics on the inside of the phone by wireless technology.

21. A phone case comprising:
a) a plastic molded part that comprises edges and at least a first corner:
b) transmitting part:
wherein the transmitting part comprises electronics or a material that has transmitting touch capabilities in the edges or in one or more corners of the phone case, the transmitting touch capabilities being able to control a computer screen with receiving touch capabilities.

22. The phone case of claim 21, wherein the transmitting touch capabilities is in the first corner of the phone case.

23. The phone case of claim 22, wherein the phone case further comprises receiving touch capabilities.

24. The phone case of claim 23, wherein a toggle exists allowing the phone case to toggle between receiving touch capabilities and transmitting touch capabilities.

25. The phone case of claim 21, wherein the touch capabilities are in more than one corner of the phone case.
